(19) United States
(12) Patent Application Publication
(10) Pub. No.: US 2008/0254674 A1
(43) Pub. Date: Oct. 16, 2008

(54) Plug assembly

(76) Inventor: Sheng-Hsin Liao, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/783,759

(22) Filed: Apr. 12, 2007

(51) Int. Cl. H01R 13/66

(52) U.S. Cl. 439/540.1

(57) ABSTRACT

A plug assembly electronically connects with a cable and includes an insulating housing, a plurality of electric terminals, and a connector. The insulating housing defines a plurality of terminal grooves. The electric terminals are disposed in terminal grooves of the insulating housing. Each electric terminal includes a contacting end and a penetrating end. The connector is jointed with the insulating housing and can be opened and closed therewith. A plurality of wiring grooves is grooved on one side wall of the connector to correspond to the penetrating ends of the electric terminals. The side wall of the connector is adjacent to the insulating housing. Hatches are defined on one side of the wiring grooves. When the connector is closed, the electric terminals electronically contact the cable by penetration accordingly. Operation is easy, time is saved, and assembly is more convenient and faster.

### BACKGROUND OF THE INVENTION

1. Field of the Invention

The present invention relates to a plug assembly, and more specifically to a plug assembly connecting electronically with a cable via an insulating penetration.

2. Description of the Prior Art

Nowadays, USB (Universal Serial Bus) plugs have become a widespread input/output interface device, and are widely used in different fields, such as for electronic devices of computers, mobile phones, etc. Moreover, the plugs such as a Mini USB, a DC, an AV, a DV, an IEEE1394, an HDMI (High-Definition Multimedia Interface), and an RJ45, are widely used in all kinds of electronic devices.

The two general methods of connecting an electric terminal of a plug and a cable are welding and insulating penetration. Thereby, the electric terminal and the cable are connected.

Referring to FIG. 1, the plug connects the electric terminal 2a and the cable 4a via the insulating penetration. A plurality of conducting wires of the cable 4a packaged with insulating layers is firstly penetrated into a plurality of corresponding wire holes (not shown) of a connector 3a. The connector 3a and the insulating body 1a are then connected. In this manner a penetration type of electric terminal 2a of an insulating body 1a electronically connects with the cable 4a via the insulating penetration.

The corresponding wires of the cable 4a usually penetrate into the corresponding wire holes from the back end of the connector 3a. To penetrate into the corresponding wire holes successfully, the wires must be aimed at the corresponding wire holes absolutely. Hence, the operation is difficult somewhat, takes some time to perform, and thereby, assembly is inconvenient.

A communication plug assembly is disclosed in TW patent M250408 (published on Nov. 11, 2004) by the applicant of the present invention. The plug assembly includes a main body, outside of which is disposed a component, inside of which defines a containing room. A plurality of terminal grooves are disposed on a front end of the main body to run through the containing room. A plurality of terminals is disposed in the terminal grooves of the main body. The plug assembly also includes a connector, a plurality of wire grooves is disposed on the front of the connector, and a locating component is disposed on the connector. A plurality of conducting wires is disposed inside the wire grooves of the connector. The locating component of the connector presses and attaches the conducting wires. The connector is fixed in the containing room of the main body, and the terminals are pushed into the terminal grooves and penetrate the conducting wire to disposed up an electrical connection therein.

The communication plug assembly overcomes the problem of the conducting wires being difficult to penetrate into the wire holes. However, the conducting wires must be disposed in the wire grooves of the connector before assembly, then the conducting wires can be pressed and attached by the locating component of the connector. When the connector is fixed inside the containing room, the terminals can be pushed into the terminal grooves to penetrate the conducting wire to disposed up an electrical connection therein. The assembling process is complex, inconvenient, and time-consuming.

Hence, the inventors of the present invention believe that these shortcomings above are able to be improved upon and suggest the present invention which is of a reasonable design and is an effective improvement based on deep research and thought.

### SUMMARY OF THE INVENTION

An object of the present invention is to provide a plug assembly, a connector and a cable for the plug assembly that can be connected rapidly, operation of which is easy and convenient, thereby saving the user time.

To achieve the above-mentioned object, a plug assembly is disclosed. The plug assembly comprises an insulating housing, which defines a plurality of terminal grooves. A plurality of electric terminals is disposed in the terminal grooves of the insulating housing, and each electric terminal comprises a contacting end and a penetrating end. A connector is jointed with the insulating housing and can be opened and closed therewith. A plurality of wiring grooves is grooved on one side wall of the connector to correspond to the penetrating ends of the electric terminals. The side wall of the connector is adjacent to the insulating housing, and hatches are defined on one side of the wiring grooves.

The advantages of the present invention are that the insulating housing connects with the connectors, and a plurality of wiring grooves are defined on the connectors. The cable can be disposed in the wiring grooves easily, and connected with the connectors and the cable rapidly. When the connector is closed, the electric terminals electronically contact the cable by penetration accordingly, operation is easy, time is saved, and assembly is more convenient and faster.

To further understand the features and technical contents of the present invention, please refer to the following detailed description and drawings related to the present invention. However, the drawings are only to be used as references and explanations, and not to limit the present invention.

### BRIEF DESCRIPTION OF THE DRAWINGS

FIG. 1 is an exploded isometric view of a plug of a prior art;

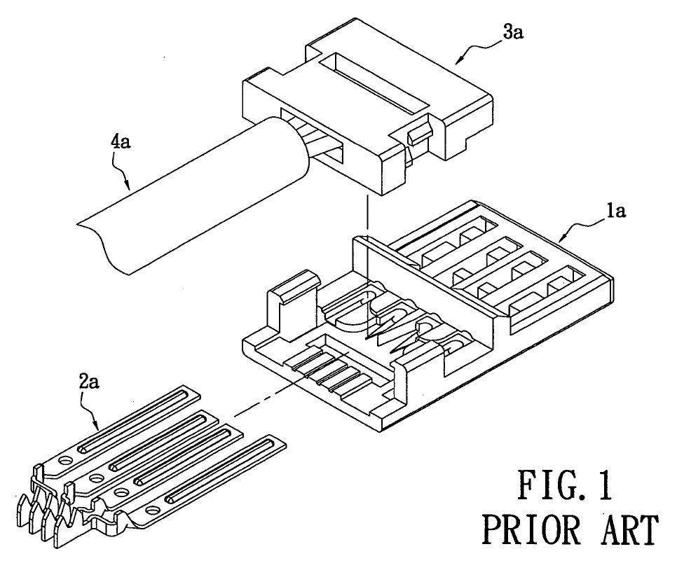

FIG. 2 is an exploded isometric view of a plug assembly of a first embodiment of the present invention;

FIG. 3 is an isometric view of a plug assembly of the present invention:

FIG. 4 is an isometric view of a plug assembly with a metal case of the present invention;

FIG. 5 is an isometric view of a plug assembly with a plastic case of the present invention;

FIG. 6 is an exploded isometric view of a plug assembly of a second embodiment of the present invention;

FIG. 7 is an exploded isometric view of a plug assembly of a third embodiment of the present invention;

FIG. 8 is an exploded isometric view of a plug assembly with a plastic case of the third embodiment of the present invention:

FIG. 9 is an exploded isometric view of a plug assembly of a forth embodiment of the present invention.

### DETAILED DESCRIPTION OF PREFERRED EMBODIMENTS

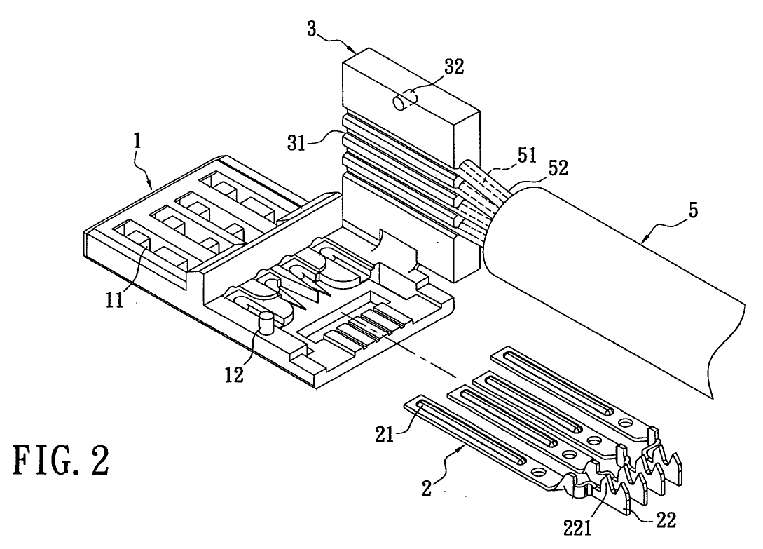

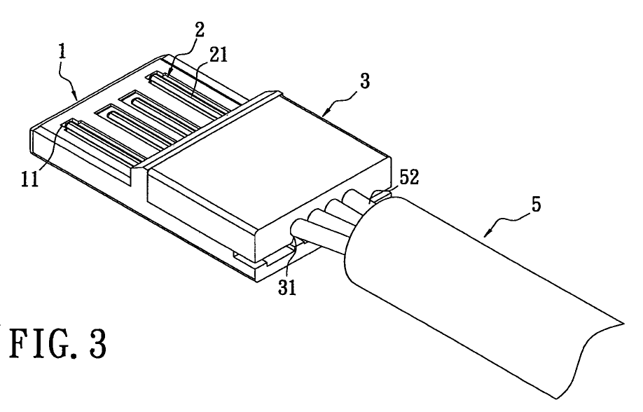

Please refer to FIGS. 2-4, in which a plug assembly of the present invention is shown. The plug is a USB plug and includes an insulating housing 1, a plurality of electric terminals 2, a connector 3, and a metal case 4. The insulating housing 1 is made of plastic and is shaped like a flat cube. A plurality of terminal grooves 11 are defined on the insulating housing 1 and extend lengthways thereof corresponding to the electric terminals 2. Spaces are defined between two adjacent terminal grooves 11.

The electric terminals 2 are made of electric conduction metal and are respectively disposed in corresponding terminal grooves 11 of the insulating housing 1. Each electric terminal 2 includes a contacting end 21 and a penetrating end 22 respectively defined on two ends thereof. The contacting end 21 electronically contacts the corresponding electric terminal of the socket. The penetrating ends 22 are vertical slices. At least one prong portion 221 is defined on each penetrating end 22 and protrudes from the top face of the insulating housing 1 to penetrate an insulating layer 52 of a cable 5.

The connector 3 is made of plastic and is flat cube-shaped. One side of the connector 3 is in-molded with one side of the insulating housing 1 and can be opened and closed relative to the insulating housing 1. A plurality of wiring grooves 31 is grooved on one side wall of the connector 3, and spaces are defined between two adjacent wiring grooves 31. The wiring grooves 31 are grooved on the bottom wall of the connector 3. The bottom wall is adjacent to the insulating housing 1. The wiring grooves 31 correspond to the penetrating ends 22 of the electric terminals 2. One side of the wiring grooves 31 defines hatches that allow the cable 5 to pass easily therethrough. The wiring grooves 31 extend to the front end and the back end of the connector 3 respectively.

A fixing device is disposed between the connector 3 and the insulating housing 1. In the present embodiment, the fixing device includes a latch 12 disposed on the insulating housing 1 and a latch hole 32 disposed on the connector 3. When the connector 3 is closed, the latch 12 and the latch hole 32 latch each other to attach the connector 3 onto the insulating housing 1. The structure of the fixing device is not limited; the latch 12 and the latch hole 32 can be exchanged, the latch 12 can be disposed on the connector 3, and the latch hole 32 can be disposed on the insulating housing 1, or other fixing devices can also be disposed thereon.

The cable 5 includes a plurality of conducting wires 51. Insulating layers 52 package the conducting wires 51. The conducting wires 51 and the insulating layers 52 are disposed in the wiring grooves 31 of the open connector 3. To close the connector 3 with the insulating housing 1, the prong portions 221 of the penetrating ends 22 of the electric terminals 2 penetrate the insulating layers 52 of the cable 5 inside the wiring grooves 31 respectively. Hence, the penetrating ends 22 of the electric terminals 2 electronically contact the conducting wires 51 of the cable 5. Thus, the electric terminals 2 and the cable 5 are connected electronically via the penetrating method.

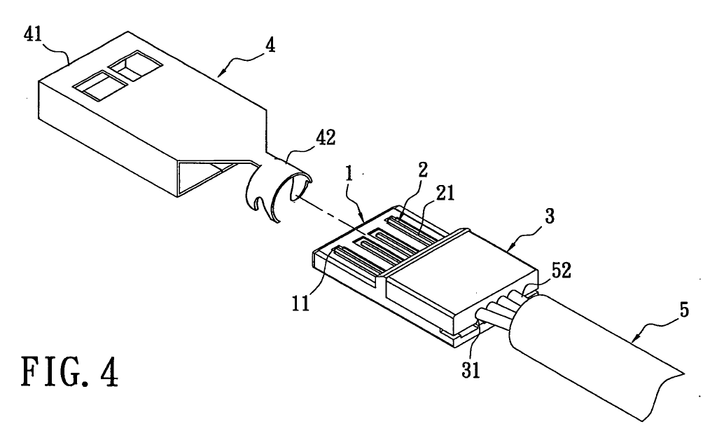

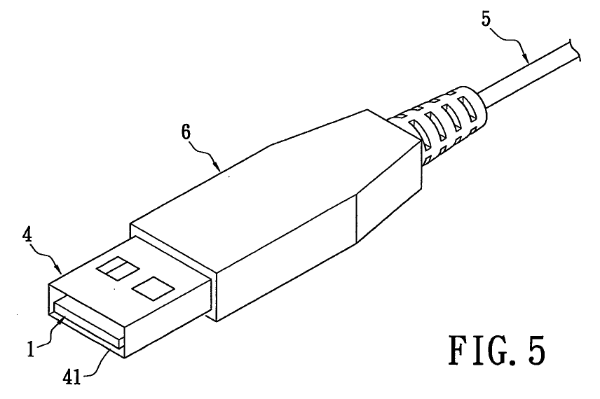

Please refer to FIG. 4. The metal case 4 is an empty case and a nest 41 is defined on the front end thereof to receive a socket. The metal case 4 packages the insulating housing 1 and the connector 3. A clamping plate 42 is defined on the back end of the metal case 4 to clamp the cable 5. After the metal case 4 has packaged the insulating housing 1 and the connector 3, a plastic shell 6 is injection-molded between the back half part of the metal case 4 and the cable 5 (as shown in FIG. 5).

The present invention can be applied in USB plugs, as well as all other types of plugs such as a Mini USB, a DC, an AV, a DV, an IEEE1394, an HDMI, and an RJ45.

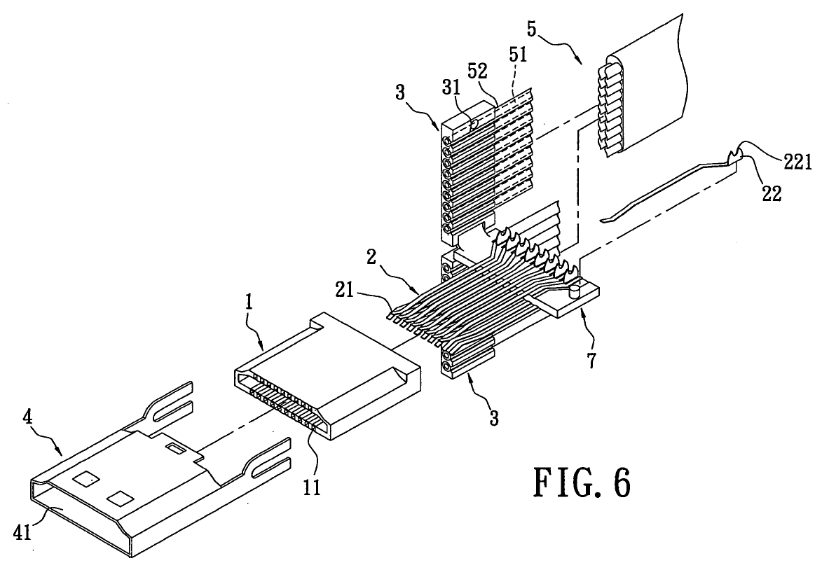

Please refer to FIG. 6, in which the plug of the present invention is shown as it is applied to an HDMI plug. The plug includes an insulating housing 1, a plurality of electric terminals 2, two connectors 3, and a metal case 4. The connectors 3 are jointed by a board element 7 and can be opened and closed by each other. The board element 7 connects with the back end of the insulating housing 1. A plurality of wiring grooves 31 is defined on the two side walls near the board element 7 of the connectors 3. The wiring grooves 31 correspond to the penetrating ends 22 of the electric terminals 2. The conducting wires 51 and the insulating layers 52 of the cable 5 are disposed in the wiring grooves 31 of the open connectors 3. To close the connectors 3 onto the board element 7, the prong portions 221 of the penetrating ends 22 of the electric terminals 2 respectively penetrate the insulating layers 52 of the cable 5 inside the wiring grooves 31. Hence, the penetrating ends 22 of the electric terminals 2 electronically contact the conducting wires 51 of the cable 5. Thus, the electric terminals 2 and the cable 5 are electronically connected via the penetrating method.

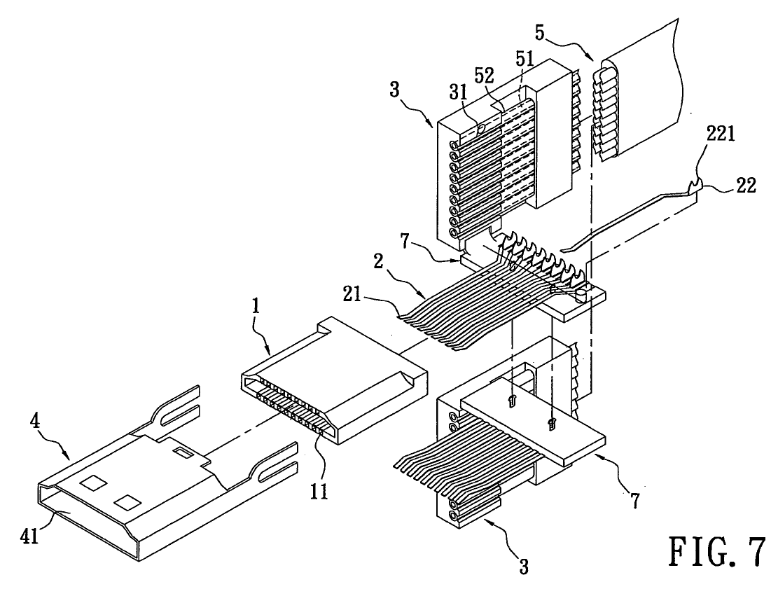

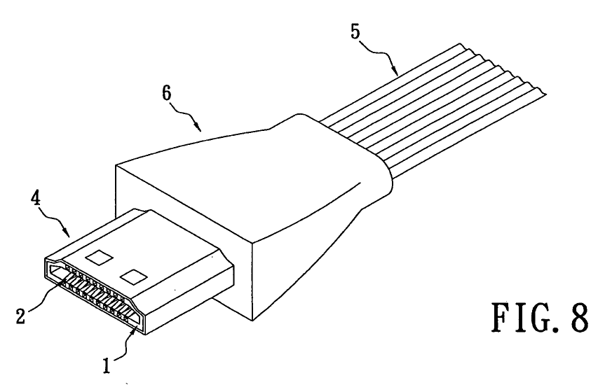

Please refer to FIG. 7. The present embodiment includes two board elements 7. The connectors 3 are jointed by the board elements 7 and can be opened and closed by each other. The board elements 7 joint each other and connect with the back end of the insulating housing 1. A plurality of wiring grooves 31 is defined on the two side walls close to the board elements 7 of the connectors 3. The wiring grooves 31 correspond to the penetrating ends 22 of the electric terminals 2. The conducting wires 51 and the insulating layers 52 of the cable 5 are disposed in the wiring grooves 31 of the open connectors 3. To close the connectors 3 on the board elements 7 respectively, the prong portions 221 of the penetrating ends 22 of the electric terminals 2 respectively penetrate the insulating layers 52 of the cable 5 inside the wiring grooves 31. Hence, the penetrating ends 22 of the electric terminals 2 electronically contact the conducting wires 51 of the cable 5. Thus, the electric terminals 2 and the cable 5 are electronically connected via the penetrating method. After the metal case 4 has packaged the insulating housing 1 and the connectors 3, a plastic shell 6 is injection-molded between the back half part of the metal case 4 and the cable 5 (show in FIG. 8).

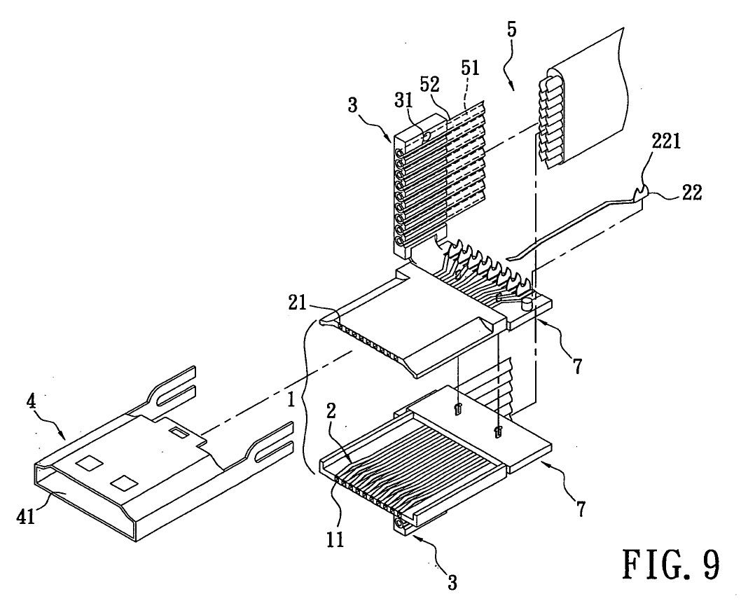

Please refer to FIG. 9. The insulating housing 1 of the present embodiment is comprised of two pieces, and the board elements 7 are in-molded on the back ends thereof respectively.

The insulating housing 1 of the present invention connects with the connectors 3, and a plurality of wiring grooves 31 are defined on the connectors 3. The conducting wires 51 and the insulating layers 52 of the cable 5 are disposed in the wiring grooves 31 to allow the connectors 3 and the cable to be connected together easily and rapidly. When the connector 3 is closed, the electric terminals 2 electronically contact the cable 5. Thereby the operation is easy, time is saved, and assembly is more convenient and faster.

What is disclosed above are only the preferred embodiments of the present invention, and therefore it is intended that the present invention not be limited to the particular embodiment disclosed. It should be understood by those skilled in the art that various equivalent changes may be made depending on the specification and the drawings of present invention without departing from the scope of the present invention.

1. A plug assembly, comprising:
an insulating housing, defining a plurality of terminal grooves thereon;
a plurality of electric terminals disposed in corresponding terminal grooves of the insulating housing, each electric terminal comprises a contacting end and a penetrating end, the penetrating end having a longitudinally extended prong portion projecting therefrom; and
a connector hingedly coupled to the insulating housing for opening and closing relative to the insulating housing, a plurality of longitudinally extended wiring grooves formed in one side wall of the connector to correspond to the penetrating ends of the electric terminals, the side wall of the connector opposing the insulating housing to longitudinally align the wiring grooves respectively with the prong portions when the connector is closed, whereby the prong portions align longitudinally with conducting wires of a cable cradled within the wiring grooves.

2. The plug assembly as claimed in claim 1, wherein the penetrating ends of the electric terminals are vertical slices, at least one prong portion is defined on each penetrating end and protrudes from the top face of the insulating housing.

3. The plug assembly as claimed in claim 1, wherein the wiring grooves are grooved on the bottom of the connector, and a latch is defined on the one side of the bottom of the connector, the wiring grooves extending to two ends of the connector.

4. The plug assembly as claimed in claim 1, wherein the connector is in-molded with the insulating housing.

5. The plug assembly as claimed in claim 1, wherein a fixing device is disposed between the connector and the insulating housing.

6. The plug assembly as claimed in claim 5, wherein the fixing device comprises a latch disposed on the insulating housing and a latch hole disposed on the connector so that when the connector is closed, the latch and the latch hole latch each other.

7. The plug assembly as claimed in claim 1, further comprising a cable, the cable including a plurality of conducting wires and insulating layers packaging the conducting wires, the conducting wires and the insulating layers being disposed in the wiring grooves, upon the connector being closed with the insulating housing, the prong portions of the penetrating ends of the electric terminals penetrating the insulating layers of the cable to contact electrically the conducting wires of the cable along a longitudinal portion thereof.

8. The plug assembly as claimed in claim 7, further comprising a metal case, wherein a nest is defined on the front end thereof, the metal case packages the insulating housing and the connector, and a clamping plate is defined on the back end of the metal case to clamp the cable.

9. The plug assembly as claimed in claim 8, wherein a plastic shell is disposed between the back half part of the metal case and the cable.

10. The plug assembly as claimed in claim 1, further comprising two connectors, which are jointed with a board element and opened and closed therewith, and the board element is jointed with the insulating body.

11. The plug assembly as claimed in claim 1, further comprising two connectors, which are jointed with two board elements and opened and closed thereto, and the board elements are jointed with the insulating body.
